(19) United States
(12) Patent Application Publication
(10) Pub. No.: US 2018/0048518 A1
(43) Pub. Date: Feb. 15, 2018

(54) INFORMATION PROCESSING APPARATUS, COMMUNICATION METHOD AND PARALLEL COMPUTER

(71) Applicant: FUJITSU LIMITED, Kawasaki-shi (JP)

(72) Inventor: Nobutaka IHARA, Kawasaki (JP)

(73) Assignee: FUJITSU LIMITED, Kawasaki-shi (JP)

(21) Appl. No.: 15/620,871

(22) Filed: Jun. 13, 2017

(30) Foreign Application Priority Data
Aug. 9, 2016 (JP) 2016-156349

(51) Int. Cl. H04L 12/24; H04L 12/863

(52) U.S. Cl. CPC H04L 41/0654; H04L 47/54

(57) ABSTRACT

An information processing apparatus includes: a storage device configured to store a program; and a processor included in a parallel computer and configured to execute the program; wherein the processor: transmits data and a first identifier designated by a communication instruction received from a process of a communication library for parallel computation to another information processing apparatus included in the parallel computer; stores the first identifier into the storage device; receives a second identifier from the another information processing apparatus; decides based on the first identifier stored in the storage device and the received second identifier whether execution of the communication instruction is completed; and notifies, when the execution of the communication instruction is completed, the process of the communication library for parallel computation that the execution of the communication instruction is completed.

### CROSS-REFERENCE TO RELATED APPLICATION

This application is based upon and claims the benefit of priority of the prior Japanese Patent Application No. 2016-156349, filed on Aug. 9, 2016, the entire contents of which are incorporated herein by reference.

### FIELD

The embodiments discussed herein are related to a communication technology for a parallel computer.

### BACKGROUND

A parallel computer that performs high performance computing (HPC) is provided.

A related art is disclosed in Japanese Laid-open Patent Publication No. 11-252184 or Japanese Laid-open Patent Publication No. 63-124162.

### SUMMARY

According to an aspect of the embodiments, an information processing apparatus includes: a storage device configured to store a program; and a processor included in a parallel computer and configured to execute the program; wherein the processor: transmits data and a first identifier designated by a communication instruction received from a process of a communication library for parallel computation to another information processing apparatus included in the parallel computer; stores the first identifier into the storage device; receives a second identifier from the another information processing apparatus; decides based on the first identifier stored in the storage device and the received second identifier whether execution of the communication instruction is completed; and notifies, when the execution of the communication instruction is completed, the process of the communication library for parallel computation that the execution of the communication instruction is completed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a hierarchical structure of components;

FIG. 2 depicts an example of a parallel computer;

FIG. 3 depicts an example of functional blocks of a computing node;

FIG. 4 illustrates an example of processing of a message passing interface (MPI) processing unit;

FIG. 5 illustrates an example of processing of a low level communication processing unit;

FIG. 6 illustrates an example of data stored in a communication instruction queue;

FIG. 7 illustrates an example of data stored in a completion queue;

FIG. 8 illustrates an example of setting of a path;

FIG. 9 illustrates an example of processing of a reception side node;

FIGS. 10 to 17 illustrate an example of communication between computing nodes; and

FIG. 18 illustrates another example of processing of a low level communication processing unit.

### DESCRIPTION OF EMBODIMENTS

In a parallel computer that performs HPC, if a failure occurs with a communication path when a node transmits data (for example, a computation result) after execution of a user program is started, the transmitted data does not arrive at a node of a transmission destination and the data is lost.

In this case, since a process of the user program continues to wait for arrival of the lost data, parallel computation may not proceed. Finally, since a limit to an execution time period is exceeded, execution of the user program is ended forcibly.

In a parallel computer that executes HPC, when a failure of a path is grasped upon allocation of jobs, a function for performing node allocation and route setting for avoiding the failure may be incorporated. For example, if a failure occurs with a path when a node transmits data after execution of a user program is started, the transmitted data does not arrive at a node of a transmission destination and the data is lost. Therefore, a mechanism for delivery confirmation and retransmission of data may be introduced.

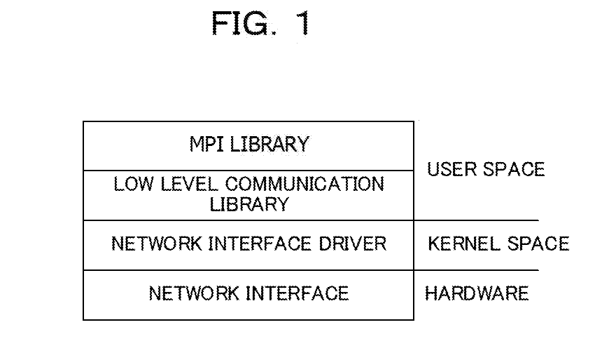

FIG. 1 illustrates an example of a hierarchical structure of components. The hierarchical structure of components illustrated in FIG. 1 may relate to communication between nodes in a parallel computer. In the parallel computer, a user program is executed. In the user program, when data is to be transferred, a communication library such as an MPI library is called. The MPI library exists, for example, in the uppermost hierarchy in a hierarchical structure. Under the MPI library, a low level communication library for controlling communication resources exists. Under the low level communication library, a network interface driver for controlling network interfaces exists. Under the network interface driver, a network interface that is hardware, for example, a network interface card (NIC), exists. The MPI library and the low level communication library belong to a user space, and the network interface driver belongs to a kernel space.

A process of the MPI library performs communication through a process of the low level communication library and a process of the network interface driver. Accordingly, if a mechanism for delivery confirmation and retransmission of data is introduced in the MPI library, a transmission function and a reception confirmation function included in the low level communication library are called by a plural number of times, and therefore, the execution time period may increase. Therefore, where high speed processing like HPC is demanded, it may not be preferable to introduce the mechanism described above into the MPI library from a point of view of the processing speed.

Therefore, delivery confirmation and retransmission of data may be performed by a mechanism newly introduced in the low level communication library.

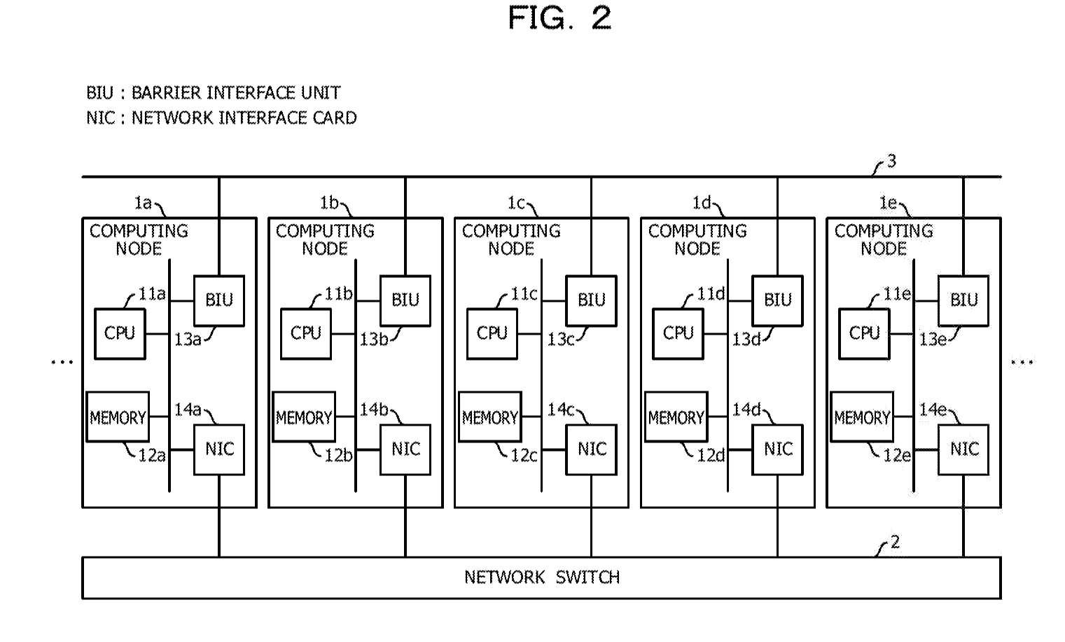

FIG. 2 depicts an example of a parallel computer. The parallel computer includes a plurality of computing nodes 1a to 1e. Each of the computing nodes 1a to 1e transmits data to another computing node or receives data from another computing node through a network switch 2. The computing nodes 1a to 1e are each coupled to a network 3 for performing barrier synchronization. Each of the computing nodes 1a to 1e transmits or receives data to be used for execution of barrier synchronization to or from another computing node through the network 3.

The computing node 1a includes a central processing unit (CPU) 11a, a memory 12a, a barrier interface unit (BIU) 13a and an NIC 14a, and the CPU 11a, the memory 12a, the BIU 13a and the NIC 14a are coupled to each other through a bus. The computing node 1b includes a CPU 11b, a memory 12b, a BIU 13b and an NIC 14b, and the CPU 11b, the memory 12b, the BIU 13b and the NIC 14b are coupled to each other through a bus. The computing node 1c includes a CPU 11c, a memory 12c, a BIU 13c and an NIC 14c, and the CPU 11c, the memory 12c, the BIU 13c and the NIC 14c are coupled to each other through a bus. The computing node 1d includes a CPU 11d, a memory 12d, a BIU 13d and an NIC 14d, and the CPU 11d, the memory 12d, the BIU 13d and the NIC 14d are coupled to each other through a bus. The computing node 1e includes a CPU 11e, a memory 12e, a BIU 13e and an NIC 14e, and the CPU 11e, the memory 12e, the BIU 13e and the NIC 14e are coupled to each other through a bus. Each of the memories 12a to 12e may be, for example, a dynamic random access memory (DRAM).

The NIC 14a, the NIC 14b, the NIC 14c, the NIC 14d and the NIC 14e are coupled to the network switch 2. The BIU 13a, the BIU 13b, the BIU 13c, the BIU 13d and the BIU 13e are coupled to the network 3 for performing barrier synchronization.

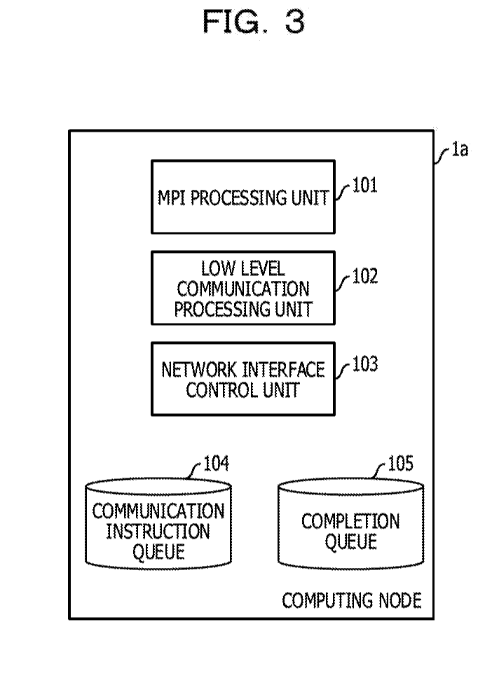

FIG. 3 depicts an example of functional blocks of a computing node. The computing node 1a includes an MPI processing unit 101, a low level communication processing unit 102, a network interface controlling unit 103, a communication instruction queue 104 and a completion queue 105. The CPU 11a in the computing node 1a loads an MPI library, a low level communication library (including a program for executing processing of the present embodiment) and a network interface driver into the memory 12a and executes them such that the MPI processing unit 101, the low level communication processing unit 102 and the network interface controlling unit 103 depicted in FIG. 3 are implemented. The communication instruction queue 104 and the completion queue 105 may be provided in a storage device of the NIC 14a, for example, in a memory. For example, the low level communication library may be a communication library by which, in order to execute a communication function provided in hardware, writing of a communication instruction, starting of communication, confirmation of reception and so forth are performed utilizing a characteristic of hardware. The low level communication library relies intensively on a function of hardware.

The MPI processing unit 101 executes processing as a process of a MPI library. The low level communication processing unit 102 executes processing as a process of a low level communication library and processing for executing delivery confirmation and retransmission of data. The network interface controlling unit 103 executes processing as a process of a network interface driver. The functional blocks of the computing nodes 1b to 1e may be similar to the functional blocks of the computing node 1a, and description of the functional blocks may be omitted.

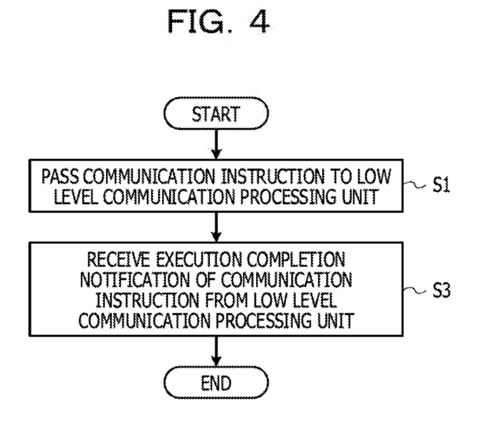

FIG. 4 illustrates an example of processing of an MPI processing unit. Here, operation of the computing node 1a is illustrated. The MPI processing unit 101 in the computing node 1a passes a communication instruction to the low level communication processing unit 102 in response to a call from a user program (FIG. 4: operation S1). The communication instruction passed in the operation S1 is an instruction for transmitting data stored in the memory 12a to another computing node (hereinafter referred to as reception side node), and includes information of the reception side node (for example, an identifier or a communication address of the reception side node), information of a reception side memory (for example, an address and a size of a memory included in the reception side node), information of a transmission side memory (for example, an address and a size of a memory included in a transmission side node (here, the computing node 1a)) or other information.

The low level communication processing unit 102 executes processing based on the communication instruction passed thereto in the operation S1. The low level communication processing unit 102 completes the processing and issues a notification of execution completion of the communication instruction to the MPI processing unit 101. The MPI processing unit 101 receives the notification of the execution completion of the communication instruction (operation S3). The MPI processing unit 101 notifies the process of the user program that the communication is completed, thereby ending the processing.

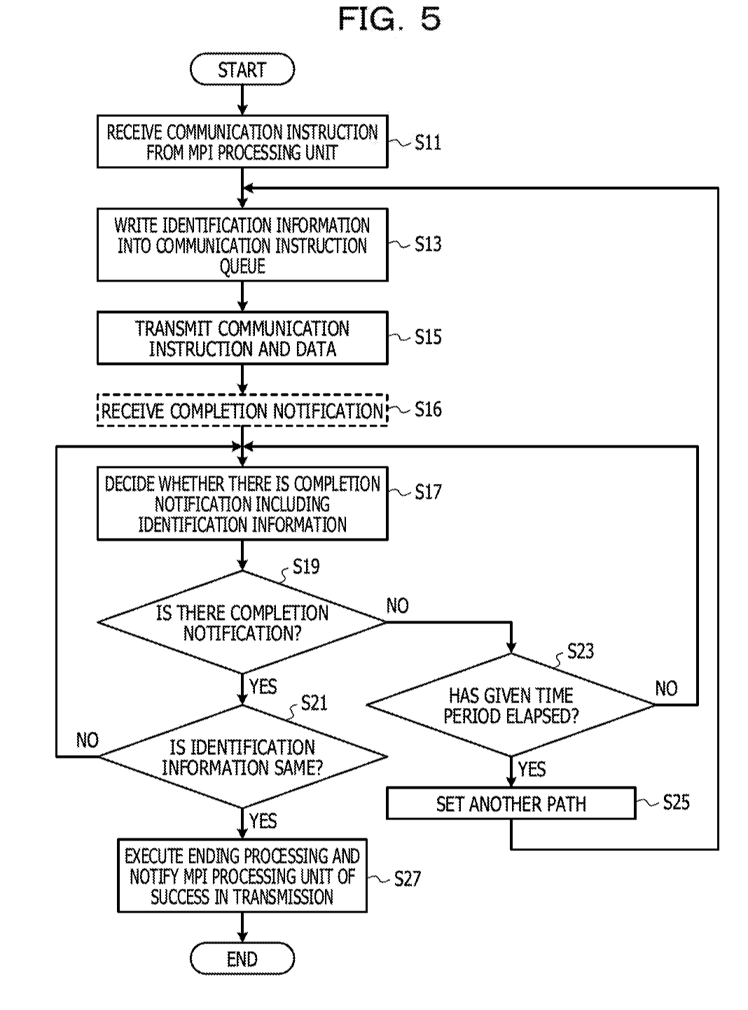

Processing executed by the low level communication processing unit 102 that has received the communication instruction from the MPI processing unit 101 is described with reference to FIGS. 5 to 8. FIG. 5 illustrates an example of processing of a low level communication processing unit. The low level communication processing unit 102 receives the communication instruction from the MPI processing unit 101 (FIG. 5: operation S11), and stores the received communication instruction into the communication instruction queue 104.

The low level communication processing unit 102 writes identification information into a given region in a region of the communication instruction queue 104 in which the communication instruction is stored (operation S13). Although the network interface controlling unit 103 operates when information is written in, in order to simplify the explanation, description of operation of the network interface controlling unit 103 is omitted. This similarly applies also to the description given below.

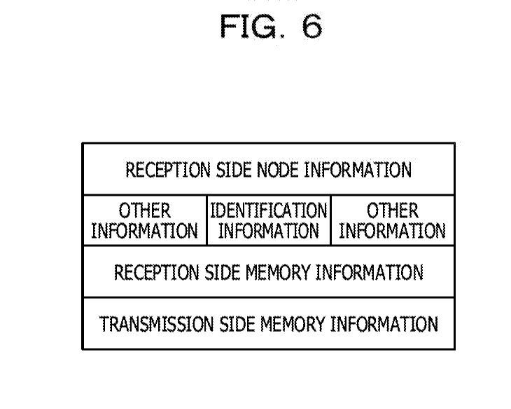

An example of data stored in a communication instruction queue is illustrated in FIG. 6. FIG. 6 illustrates an example in which information of the reception side node, identification information, information of the reception side memory, information of the transmission side memory and other information are stored in the communication instruction queue. The identification information may be unique information allocated to the communication instruction, for example, information indicative of the number of times of transmission. The information of the reception side node includes information of a path when data is transmitted.

The low level communication processing unit 102 transmits the communication instruction stored in the communication instruction queue 104 and data designated by the communication instruction, for example, data in the memory 12a specified by the information of the transmission side memory, to the reception side node by the NIC 14a (operation S15).

The computing node 1a that is the transmission side node receives a completion notification from the reception side node by the NIC 14a (operation S16), and stores the completion notification into the completion queue 105 of the NIC 14a. For example, since the processing in the operation S16 may not necessarily be performed after the processing in the operation S15, the block of the operation S16 is indicated by a broken line.

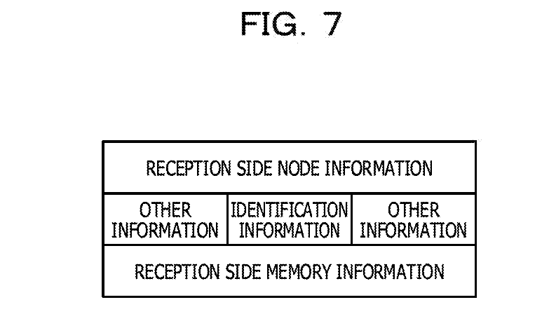

An example of data stored in a completion queue is illustrated in FIG. 7. FIG. 7 illustrates an example in which information of the reception side node, identification information, information of the reception side memory and other information are stored in the completion queue. If the completion notification stored in the completion queue 105 is a completion notification received from the reception side node that has received the data transmitted in the operation S15, the identification information transmitted in the operation S15 and the identification information stored in the completion queue 105 may be the same as each other.

The low level communication processing unit 102 decides whether a completion notification including identification information is stored in the completion queue 105 (operation S17).

If a completion notification including identification information is stored in the completion queue 105 (operation S19: Yes route), the low level communication processing unit 102 decides whether the identification information included in the completion notification and the identification information stored in the communication instruction queue 104 are the same as each other (operation S21). If the two pieces of identification information are not the same as each other (operation S21: No route), since delivery of the data transmitted in the operation S15 is not confirmed, the processing returns to the operation S17. If the two pieces of identification information are the same as each other (operation S21: Yes route), the processing advances to the operation S27.

If a completion notification including identification information is not stored in the completion queue 105 (operation S19: No route), the low level communication processing unit 102 decides whether a given period of time has elapsed after the data is transmitted in the operation S15 (operation S23). If the given time period has not elapsed (operation S23: No route), the processing returns to the operation S17. If the given time period has elapsed (operation S23: Yes route), the low level communication processing unit 102 sets a path other than the path used when the data is transmitted in the operation S15 as a transmission path for the data (operation S25). The processing returns to the operation S13. In this case, in the operation S13, identification information different from the identification information in the preceding operation cycle is written in.

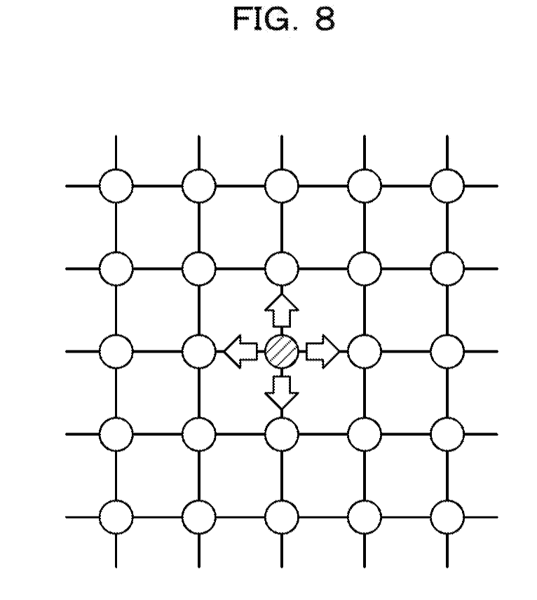

FIG. 8 illustrates an example of setting of a path. In FIG. 8, a circular pattern represents a computing node, and a computing node indicated by hatching represents a transmission side node. In FIG. 8, a two-dimensional coordinate (x, y) is applied to each computing node, and the transmission side node sends out data to a path to one of four computing nodes neighboring therewith. While the computing nodes are arranged on a two-dimensional plane in FIG. 8, the nodes may be arranged, for example, in a three-dimensional space. In this case, data is sent out to a path to one of six computing nodes neighboring with the transmission side node.

The low level communication processing unit 102 executes processing for ending execution of the communication instruction received from the MPI processing unit 101, for example, processing for clearing the communication instruction queue 104 and the completion queue 105, and notifies the MPI processing unit 101 of execution completion of the communication instruction, for example, of success in transmission (operation S27). The processing ends therewith.

For example, if a completion notification including original identification information is received after the data is retransmitted with new identification information allocated thereto, a notification relating to one of the original identification information and the new identification information does not need to be issued to the MPI processing unit 101. The possibility that an overlapping notification is passed to the MPI processing unit 101 may be reduced.

As described above, whether or not identification information same as transmitted identification information is received is decided to decide whether or not data transmitted together with the identification information is received by the reception side node. By execution of processing for confirmation of delivery and retransmission by the low level communication processing unit 102, the MPI processing unit 101 may not need to call a transmission function and a reception confirmation function of the low level communication library many times. Since the processing is simplified in this manner, the execution time period of the user program may be shortened.

For example, the possibility that the user program is forcibly ended may be reduced and more stabilized program execution may be guaranteed.

Since the low level communication library controls communication resources, confirmation of existence of a path and confirmation of loss of a communication instruction are performed simply in one transmission function rather than those by the MPI processing unit 101. For example, even if retransmission is performed, the MPI processing unit 101 may recognize that the processing progresses without any problem.

If a completion notification including original identification information is received after data is retransmitted with new identification information allocated thereto, the completion notification including the original identification information may be discarded.

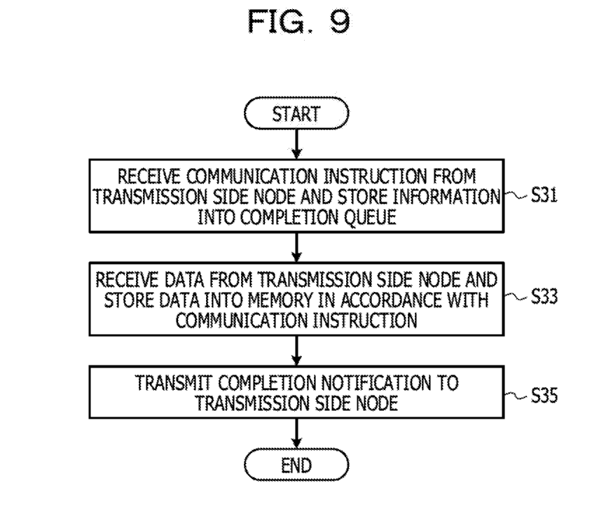

FIG. 9 illustrates an example of processing of a reception side node. The reception side node may be, for example, the computing node 1b. The reception side node receives a communication instruction from the computing node 1a that is a transmission side node by the NIC 14b, extracts information of the reception side node, identification information, information of the reception side memory and other information from the communication instruction, and stores the extracted information into the completion queue 105 of the NIC 14b (FIG. 9: operation S31). Therefore, the data stored in the completion queue 105 of the reception side node and the data stored in the completion queue 105 of the transmission side node are the same as each other.

The reception side node receives the data from the computing node 1a that is the transmission side node by the NIC 14b, and stores the data into the memory 12b in accordance with the information of the reception side memory included in the communication instruction (operation S33).

The reception side node transmits a completion notification including the data stored in the completion queue 105 to the transmission side node by the NIC 14b (operation S35). The processing ends therewith.

If the reception side node successfully receives the data by such processing as described above, the identification information same as the identification information transmitted by the transmission side node is transmitted from the reception side node to the transmission side node.

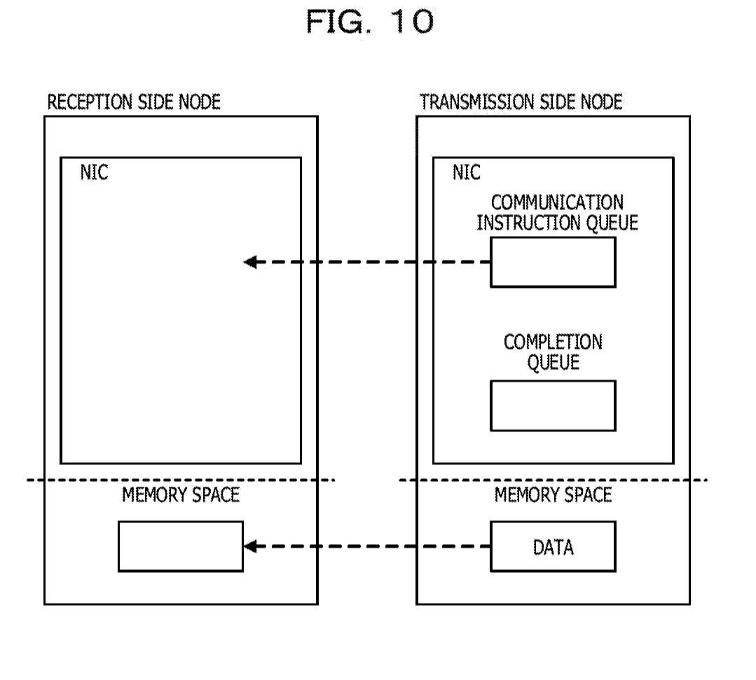

FIGS. 10 to 17 illustrate an example of communication between computing nodes.

As illustrated in FIG. 10, data and a communication instruction are transmitted from a transmission side node to a reception side node. The data is transmitted from the memory space of the transmission side node to the memory space of the reception side node, and the communication instruction is transmitted from the communication instruction queue 104 in the NIC 14a of the transmission side node to the completion queue 105 in the NIC 14b of the reception side node.

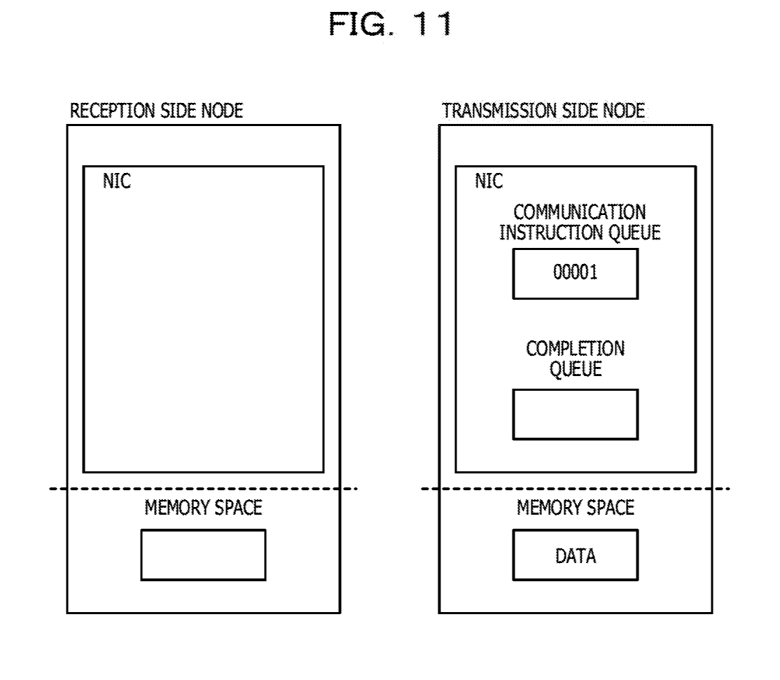

If a communication instruction is generated in the transmission side node, the communication instruction including identification information is stored into the communication instruction queue 104 as illustrated in FIG. 11. In FIG. 11, the identification information is “00001.”

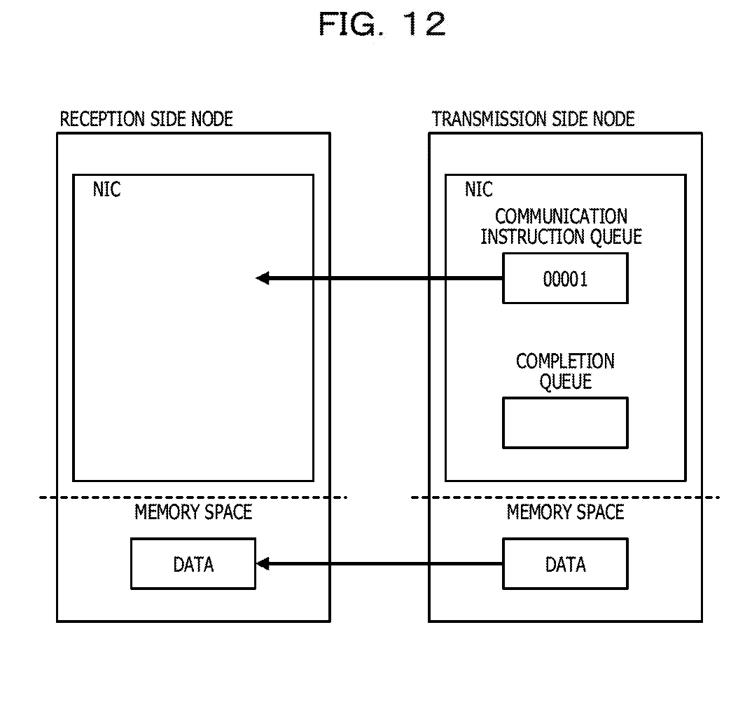

As illustrated in FIG. 12, the communication instruction stored in the communication instruction queue 104 and the data stored in the memory 12a are transmitted to the reception side node. The data is stored into the memory 12b of the reception side node, and the identification information and so forth extracted from the communication instruction are stored into the completion queue 105.

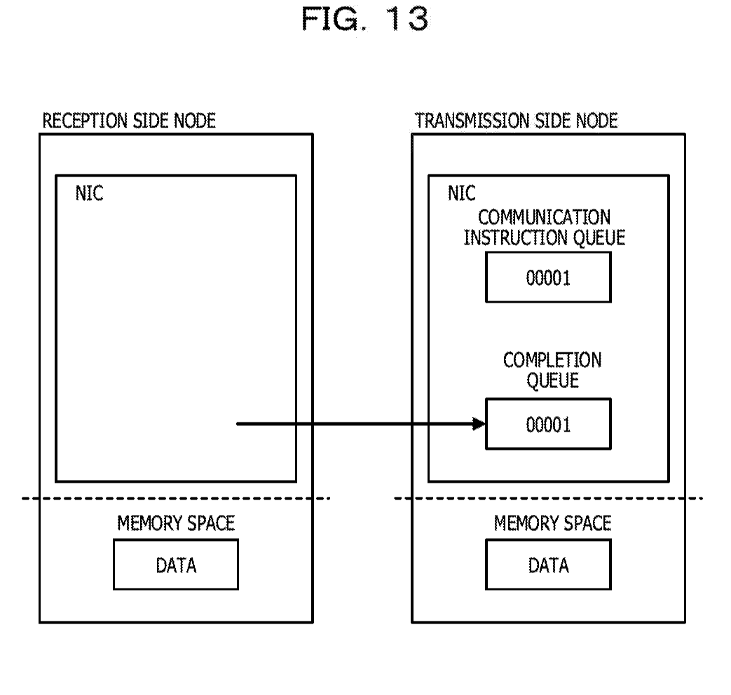

As illustrated in FIG. 13, a completion notification including the identification information and so forth stored in the completion queue 105 of the reception side node is transmitted to the transmission side node and stored into the completion queue 105 of the transmission side node.

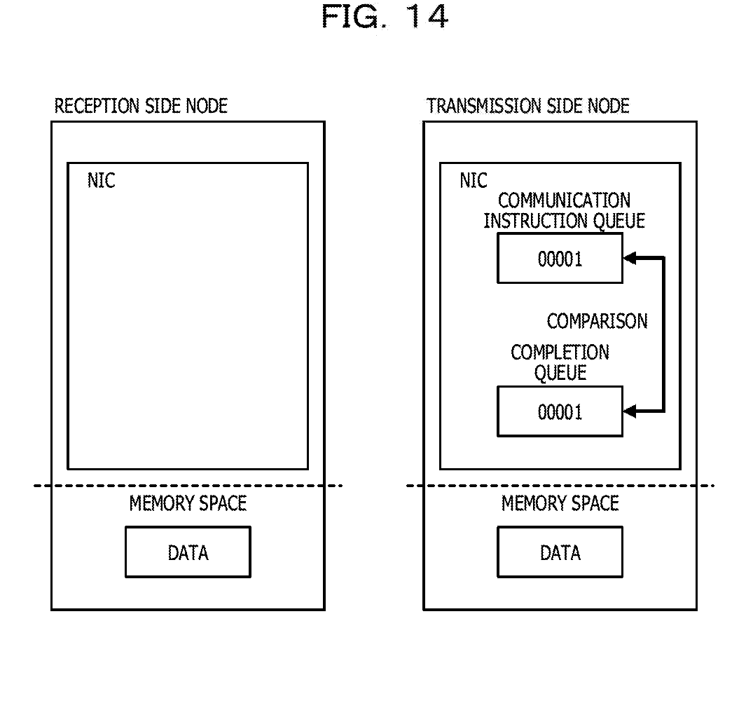

As illustrated in FIG. 14, the identification information stored in the communication instruction queue 104 of the transmission side node and the identification information stored in the completion queue 105 of the transmission side node are compared with each other. If the two pieces of identification information are the same as each other, it is regarded that the data is received by the reception side node.

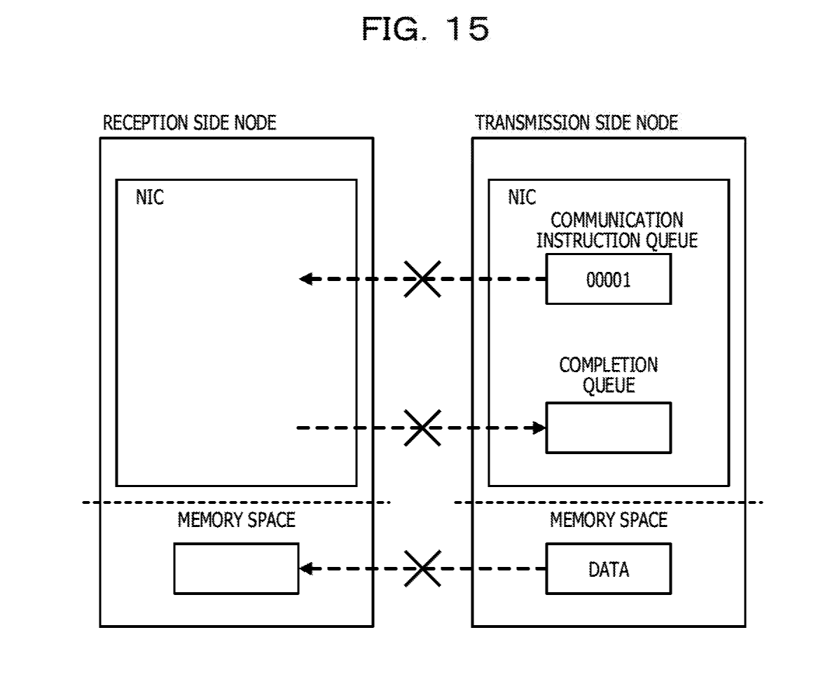

If a failure occurs with a path between the transmission side node and the reception side node as illustrated in FIG. 15 and disables communication between them, the communication instruction and the data are lost, and no identification information is sent back from the reception side node. In such a case, it is regarded that the data is not received by the reception side node.

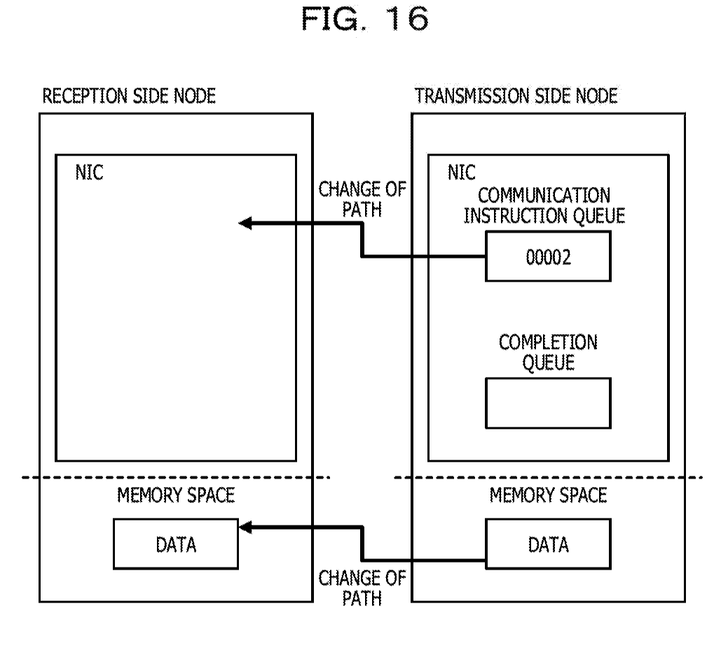

If the data is not received by the reception side node, the transmission side node changes the path and then transmits the communication instruction and the data to the reception side node as illustrated in FIG. 16. The data is stored into the memory 12b of the reception side node, and the identification information extracted from the communication instruction, in FIG. 16, “00002” and so forth, is stored into the completion queue 105 of the reception side node.

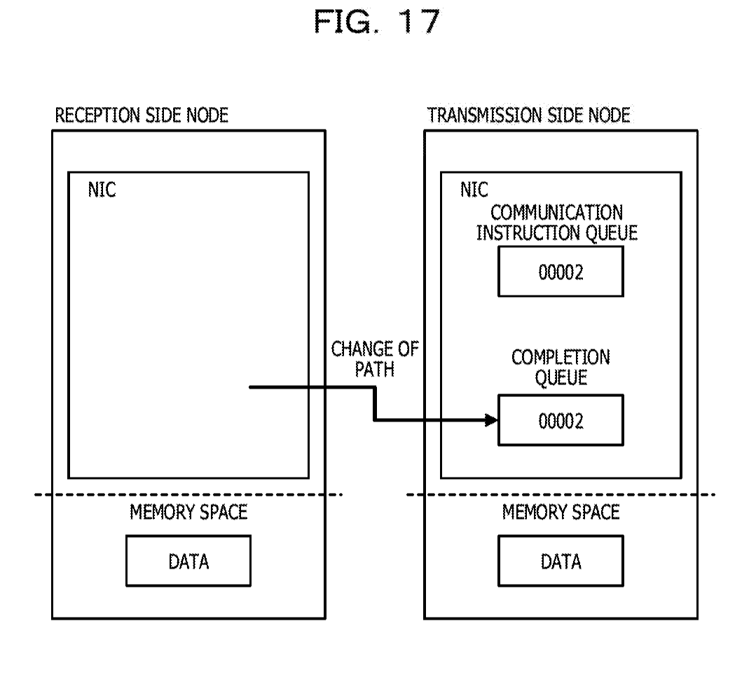

As illustrated in FIG. 17, the completion notification including the identification information and so forth stored in the completion queue 105 of the reception side node is transmitted to the transmission side node and stored into the completion queue 105 of the transmission side node. The identification information stored in the communication instruction queue 104 of the transmission side node and the identification information stored in the completion queue 105 of the transmission side node are compared with each other, and since the two pieces of identification information are the same as each other, it is regarded that the data is received by the reception side node.

If a plurality of communication instructions are issued at a time from the MPI processing unit 101, arrival of some completion notification may be delayed by the distance between the reception side node and the transmission side node or the congestion situation of the path. Therefore, if the processing described above is executed for each communication instruction, an increased execution time period may be required. The order in which the communication instructions are transmitted and the order in which the completion notifications are received may not be the same as each other. Therefore, such processing as described below may be executed.

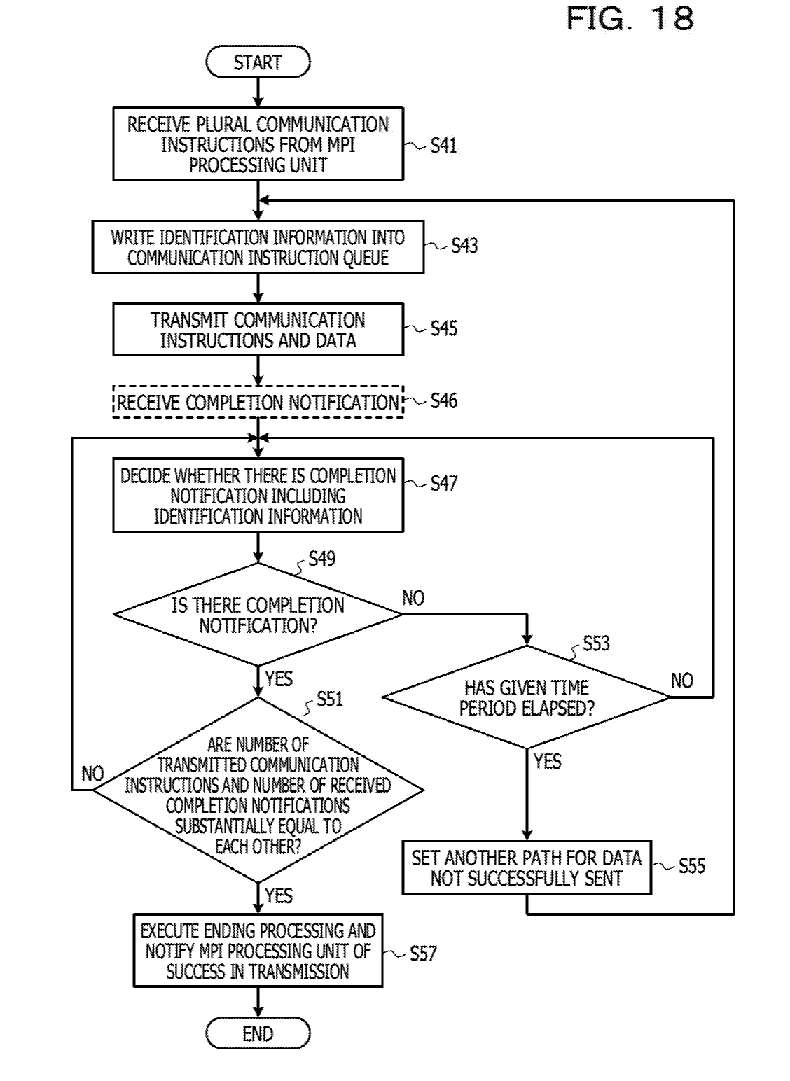

FIG. 18 illustrates another example of processing of a low level communication processing unit. In FIG. 18, processing executed by the low level communication processing unit 102 that has received communication instructions from the MPI processing unit 101 is illustrated. The low level communication processing unit 102 receives a plurality of communication instructions from the MPI processing unit 101 (FIG. 18: operation S41) and stores each of the plurality of communication instructions into the communication instruction queue 104.

The low level communication processing unit 102 writes, for each of the plurality of communication instructions, identification information into a given region in a region in which the communication instruction is stored (operation S43). When information is written in, the network interface controlling unit 103 operates. However, in order to simplify the explanation, description of operation of the network interface controlling unit 103 is omitted. This similarly applies also to the description given below.

The low level communication processing unit 102 transmits the communication instructions stored in the communication instruction queue 104 and data designated by the communication instructions, for example, data in the memory 12a specified by the information of the transmission side memory, to the reception side node by the NIC 14a (operation S45). For example, a plurality of reception side nodes may be involved or a plurality of communication instructions and data pieces may be transmitted to a single reception side node.

The computing node 1a that is the transmission side node receives completion notifications from the reception side node by the NIC 14a (operation S46) and stores the completion notifications into the completion queue 105 of the NIC 14a. Since the operation S46 may not necessarily be performed after the processing of the operation S45, the block of the operation S46 is indicated by a broken line.

The low level communication processing unit 102 decides whether completion notifications including identification information are stored in the completion queue 105 (operation S47).

If completion notifications including identification information are stored in the completion queue 105 (operation S49: Yes route), the low level communication processing unit 102 decides whether the number of transmitted communication instructions and the number of received completion notifications are substantially equal to each other (operation S51). If the number of transmitted communication instructions and the number of received completion notifications are not substantially equal to each other (operation S51: No route), the processing returns to the operation S47. If the number of transmitted communication instructions and the number of received completion notifications are substantially equal to each other (operation S51: Yes route), the processing advances to the operation S57.

If no completion notification including identification information is stored in the completion queue 105 (operation S49: No route), the low level communication processing unit 102 decides whether a given period of time has elapsed after data is transmitted in the operation S45 (operation S53). If the given time period has not elapsed (operation S53: No route), the processing returns to the operation S47. If the given time period has elapsed (operation S53: Yes route), the low level communication processing unit 102 sets, for a piece or pieces of data that have not successfully been sent to the reception side node, a path other than the path used when the data is transmitted in the operation S45 as a transmission path for the data (operation S55). The processing returns to the operation S43. The processing of the operations beginning with the operation S43 is executed again only for the piece or pieces of data that have not successfully been sent to the reception side node. In this case, in the operation S43, identification information different from the identification information in the preceding operation cycle is written in.

The low level communication processing unit 102 executes processing for ending execution of the communication instructions received from the MPI processing unit 101, for example, processing for clearing the communication instruction queue 104 and the completion queue 105, and notifies the MPI processing unit 101 of execution completion of the communication instructions, for example, of success in transmission (operation S57). The processing ends therewith.

By such processing as described above, even in a case in which a plurality of communication instructions are received at a time from the MPI processing unit 101, elongation of the processing time period may be suppressed.

For example, the functional block configuration of the computing node 1a described above may not coincide with a program module configuration.

Also in the processing flow, as long as a result of processing does not change, the order of processing operations may be changed or processing operations may be executed in parallel.

An information processing apparatus includes (A) a storage device, (B) a communication unit configured to transmit data and a first identifier designated in a communication instruction received from a process of a communication library for parallel computation to another information processing apparatus included in a parallel computer, store the first identifier into the storage device and receive a second identifier from the another information processing apparatus, and (C) a decision unit configured to decide, based on the first identifier stored in the storage device and the second identifier received by the communication unit, whether execution of the communication instruction is completed and notify, when the execution of the communication instruction is completed, the process of the communication library for parallel computation that the execution of the communication instruction is completed.

With such a configuration, delivery confirmation of the data may be performed in the parallel computer. Compared with a case in which delivery of data is confirmed by the communication library for parallel computation, the possibility that a communication library in a lower layer is called many times may be reduced, and the time period taken for confirmation of delivery may be shortened.

The decision unit (c1) may decide whether or not the first identifier and the second identifier are the same as each other and, when the first identifier and the second identifier are the same as each other, may notify the process of the communication library for parallel computation that execution of the communication instruction is completed. It may be confirmed appropriately that data is delivered to the another information processing apparatus in this manner.

A plurality of communication instructions may be involved. The communication unit (b1) transmits data pieces and first identifiers to another information processing apparatus included in the parallel computer and receives second identifiers from the another information processing apparatus. The decision unit (c2) may decide whether the number of transmitted first identifiers and the number of received second identifiers are substantially equal to each other and, when the number of first identifiers and the number of second identifiers are substantially equal to each other, may notify the process of the communication library for parallel computation that execution of the communication instructions is completed. In this manner, even if a plurality of communication instructions are involved, confirmation of delivery may be performed without a delay of processing.

The present information processing apparatus (D) may further include a path specification unit that specifies, when the second identifier is not received even after a given period of time has elapsed after the first identifier is transmitted, a second path different from a first path along which the data and the first identifier are transmitted. The communication unit (b2) may transmit the data and a third identifier different from the first identifier to the another information processing apparatus through the second path specified by the path specification unit. For example, even when a failure occurs with the first path, data may be delivered to the another information processing apparatus.

The communication library for parallel computation may be a library of MPIs.

A communication method includes processing operations for (E) transmitting data and a first identifier designated by a communication instruction received from a process of a communication library for parallel computation to another computer included in a parallel computer and storing the first identifier into a storage device, (F) receiving a second identifier from the another computer, (G) deciding based on the first identifier stored in the storage device and the received second identifier whether execution of the communication instruction is completed, and (H) notifying, when the execution of the communication instruction is completed, the process of the communication library for parallel computation that the execution of the communication instruction is completed.

A program for causing a processor to perform the processing by the method described above may be produced. The program is stored into a computer-readable storage medium or a storage device such as a flexible disk, a compact disk read only memory (CD-ROM), a magneto-optical disk, a semiconductor memory or a hard disk. An intermediate processing result is temporarily stored into a storage device such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a storage device configured to store a program; and
a processor included in a parallel computer and configured to execute the program; wherein
the processor:
transmits data and a first identifier designated by a communication instruction received from a process of a communication library for parallel computation to another information processing apparatus included in the parallel computer;
stores the first identifier into the storage device;
receives a second identifier from the another information processing apparatus;
decides based on the first identifier stored in the storage device and the received second identifier whether execution of the communication instruction is completed; and
notifies, when the execution of the communication instruction is completed, the process of the communication library for parallel computation that the execution of the communication instruction is completed.

2. The information processing apparatus according to claim 1, wherein
the processor:
decides whether or not the first identifier and the second identifier are the same as each other; and
notifies, when the first identifier and the second identifier are the same as each other, the process of the communication library for parallel computation that the execution of the communication instruction is completed.

3. The information processing apparatus according to claim 1, wherein
the communication library is a library of message passing interfaces, and
the processor executes a decision and a notification using a low level communication library called into the message passing interface library.

4. The information processing apparatus according to claim 1, wherein
the communication instruction includes a plurality of communication instructions, and
the processor:
transmits, for each of the plurality of communication instructions, the data and the first identifier designated by the respective communication instructions to the another information processing apparatus included in the parallel computer;
receives the second identifier from the other information processing apparatus in response to a transmission of the data and the first identifier for each of the plurality of communication instructions;
decides whether a number of the first identifiers and a number of the received second identifiers are equal to each other; and
notifies, when the number of the first identifiers and the number of the second identifiers are equal to each other, the process of the communication library for parallel computation that the execution of the communication instructions is completed.

5. The information processing apparatus according to claim 1, wherein
the processor:
specifies, when the second identifier is not received after a given period of time elapses after the first identifier is transmitted, a second path different from a first path along which the data and the first identifier are transmitted; and
transmits the data and a third identifier different from the first identifier to the another information processing apparatus through the second path.

6. The information processing apparatus according to claim 5, wherein
when, after the data and the third identifier are transmitted to the another information processing apparatus, the second identifier is received and a fourth identifier corresponding to the third identifier is received from the another information processing apparatus, the processor performs notification corresponding to one of the second identifier and the fourth identifier to the process of the communication library for parallel computation.

7. A communication method comprising:
transmitting, by a processor in an information processing apparatus in a parallel computer, data and a first identifier designated by a communication instruction received from a process of a communication library for parallel computation to another information processing apparatus included in the parallel computer;
storing the first identifier into a storage device;
receiving a second identifier from the another information processing apparatus;
deciding based on the first identifier stored in the storage device and the received second identifier whether execution of the communication instruction is completed; and
notifying, when the execution of the communication instruction is completed, the process of the communication library for parallel computation that the execution of the communication instruction is completed.

8. The communication method according to claim 7, further comprising:
deciding whether or not the first identifier and the second identifier are the same as each other; and
notifying, when the first identifier and the second identifier are the same as each other, the process of the communication library for parallel computation that the execution of the communication instruction is completed.

9. The communication method according to claim 7, wherein
the communication library is a library of message passing interfaces, and
the deciding and the notifying are executed using a low level communication library called into the message passing interface library.

10. The communication method according to claim 7, further comprising:
transmitting, for each of a plurality of communication instructions when the communication instruction includes the plurality of communication instructions, the data and the first identifier designated by the respective communication instructions to the another information processing apparatus;
receiving the second identifier from the other information processing apparatus in response to a transmission of the data and the first identifier for each of the plurality of communication instructions;
deciding whether a number of the first identifiers and a number of the received second identifiers are equal to each other; and
notifying, when the number of the first identifiers and the number of the second identifiers are equal to each other, the process of the communication library for parallel computation that the execution of the communication instructions is completed.

11. The communication method according to claim 7, further comprising:
specifying, when the second identifier is not received after a given period of time elapses after the first identifier is transmitted, a second path different from a first path along which the data and the first identifier are transmitted; and
transmitting the data and a third identifier different from the first identifier to the another information processing apparatus through the second path.

12. The communication method according to claim 11, wherein
performing, when, after the data and the third identifier are transmitted to the another information processing apparatus, the second identifier is received and a fourth identifier corresponding to the third identifier is received from the another information processing apparatus, notification corresponding to one of the second identifier and the fourth identifier to the process of the communication library for parallel computation.

13. A parallel computer comprising:
a first information processing apparatus; and
a second information processing apparatus; wherein
the first information processing apparatus:
transmits data and a first identifier designated by a communication instruction received from a process of a communication library for parallel computation to the second information processing apparatus;
stores the first identifier into a storage device;
receives a second identifier from the second information processing apparatus;
decides based on the first identifier stored in the storage device and the second identifier whether execution of the communication instruction is completed; and
notifies, when the execution of the communication instruction is completed, the process of the communication library for parallel computation that the execution of the communication instruction is completed; and
the second information processing apparatus:
receives the data and the first identifier from the first information processing apparatus; and
transmits the second identifier that is a same identifier as the first identifier to the first information processing apparatus.

14. The parallel computer according to claim 13, wherein
the first information processing apparatus:
decides whether or not the first identifier and the second identifier are the same as each other; and
notifies, when the first identifier and the second identifier are the same as each other, the process of the communication library for parallel computation that the execution of the communication instruction is completed.

15. The parallel computer according to claim 13, wherein
the communication library is a library of message passing interfaces, and
the first information processing apparatus executes a decision and a notification using a low level communication library called into the message passing interface library.

16. The parallel computer according to claim 13, wherein
the communication instruction includes a plurality of communication instructions, and
the first information processing apparatus:
transmits, for each of the plurality of communication instructions, the data and the first identifier designated by the respective communication instructions to the another information processing apparatus included in the parallel computer;
receives the second identifier from the other information processing apparatus in response to a transmission of the data and the first identifier for each of the plurality of communication instructions;
decides whether a number of the first identifiers and a number of the received second identifiers are equal to each other; and
notifies, when the number of the first identifiers and the number of the second identifiers are equal to each other, the process of the communication library for parallel computation that the execution of the communication instructions is completed.

17. The parallel computer according to claim 13, wherein
the first information processing apparatus:
specifies, when the second identifier is not received after a given period of time elapses after the first identifier is transmitted, a second path different from a first path along which the data and the first identifier are transmitted; and
transmits the data and a third identifier different from the first identifier to the another information processing apparatus through the second path.

18. The parallel computer according to claim 17, wherein
when, after the data and the third identifier are transmitted to the another information processing apparatus, the second identifier is received and a fourth identifier corresponding to the third identifier is received from the another information processing apparatus, the first information processing apparatus performs notification corresponding to one of the second identifier and the fourth identifier to the process of the communication library for parallel computation.
